(19) United States
(12) Patent Application Publication
(10) Pub. No.: US 2026/0258853 A1
(43) Pub. Date: Sep. 3, 2026

(54) VEHICLE TRANSMISSION

(71) Applicant: Aisin Corporation, Kariya (JP)

(72) Inventor: Hiroshi ISONO, Kariya-shi (JP)

(73) Assignee: Aisin Corporation, Kariya (JP)

(21) Appl. No.: 19/534,036

(22) Filed: Feb. 9, 2026

(30) Foreign Application Priority Data
Feb. 28, 2025 (JP) 2025-032156

(51) Int. Cl. F16H 3/66

(52) U.S. Cl. CPC F16H 3/66; F16H 2200/0021; F16H 2200/2007; F16H 2200/2035

(57) ABSTRACT

A vehicle transmission includes an input member, an output member, a first planetary gear mechanism, a second planetary gear mechanism, a first engagement mechanism, and a second engagement mechanism. The input member is drive-connected to a drive source. The output member is drive-connected to a wheel. The first engagement mechanism and the second engagement mechanism are each switchable between an engaged state in which a rotating element is locked to a non-rotating member and a released state in which the rotating element is rotatable. The first planetary gear mechanism, the second planetary gear mechanism, the first engagement mechanism, and the second engagement mechanism are arranged coaxially with one another. The first planetary gear mechanism is arranged on an axial-direction first side of the second planetary gear mechanism. The first engagement mechanism and the second engagement mechanism are arranged on an axial-direction second side of the second planetary gear mechanism.

### CROSS REFERENCE TO RELATED APPLICATIONS

This application is based on and claims priority under 35 U.S.C. § 119 to Japanese Patent Application No. 2025-032156, filed on February 28, 2025, the entire content of which is incorporated herein by reference.

### TECHNICAL FIELD

This disclosure generally relates to a vehicle transmission that includes an input member to be drive-connected to a drive source, an output member to be drive-connected to a wheel, a planetary gear mechanism, and an engagement mechanism.

### BACKGROUND DISCUSSION

One example of such a vehicle transmission is disclosed in WO2024/166899A (Reference 1). In the following description of the BACKGROUND DISCUSSION, reference signs in Reference 1 are cited in parentheses.

A vehicle transmission (10) in Reference 1 includes a first engagement mechanism (3) and a second engagement mechanism (4) that are arranged coaxially with each other. The first engagement mechanism (3) is configured as a friction clutch that connects and disconnects power transmission between two rotating elements (E5, E6). The second engagement mechanism (4) is configured as a brake that selectively locks the rotating element (E5) to a non-rotating element (NR). Controlling engagement states of the first engagement mechanism (3) and the second engagement mechanism (4) can form either one of two gear shift stages.

In the above-described vehicle transmission (10), the first engagement mechanism (3) includes a first support member (33) rotating integrally with one rotating element (E5), a second support member (34) rotating integrally with another rotating element (E6), a first frictional engagement element (31) supported by the first support member (33), and a second frictional engagement element (32) supported by the second support member (34). The first frictional engagement element (31) and the second frictional engagement element (32) are pressed to each other in an axial direction (L) in such a way as to engage with each other. Thereby, the first engagement mechanism (3) is brought into an engagement state.

As described above, both the first frictional engagement element (31) and the second frictional engagement element (32) are rotating members. For this reason, a power transmission structure in the first engagement mechanism (3) becomes complex. As a result, durability of the first engagement mechanism (3) is reduced. In order to improve durability of the first engagement mechanism (3), it is conceivable, for example, to increase the first friction engagement element (31), the second friction engagement element (32), and radial-direction sizes of thrust bearings that support thrust loads generated when the first and second friction engagement elements (31, 32) are pressed. However, this approach results in an increased size of the first engagement mechanism (3), which is disadvantageous.

A need thus exists for a vehicle transmission which is not susceptible to the drawback mentioned above.

### SUMMARY

A vehicle transmission according to this disclosure includes an input member, an output member, a first planetary gear mechanism, a second planetary gear mechanism, a first engagement mechanism, and a second engagement mechanism. The input member is drive-connected to a drive source. The output member is drive-connected to a wheel. The first planetary gear mechanism includes a first rotating element, a second rotating element, and a third rotating element. The second planetary gear mechanism includes a fourth rotating element, a fifth rotating element, and a sixth rotating element. The first rotating element is coupled to the input member in such a way as to rotate integrally with the input member. The third rotating element is coupled to the output member in such a way as to rotate integrally with the output member. The first rotating element and the fourth rotating element are coupled to each other in such a way as to rotate integrally with each other. The fifth rotating element is coupled to the second rotating element or the third rotating element in such a way as to rotate integrally with the second rotating element or the third rotating element. The first engagement mechanism is configured to be switchable between an engaged state in which the second rotating element is locked to a non-rotating member and a released state in which the second rotating element is rotatable. The second engagement mechanism is configured to be switchable between an engaged state in which the sixth rotating element is locked to the non-rotating member and a released state in which the sixth rotating element is rotatable. The first planetary gear mechanism, the second planetary gear mechanism, the first engagement mechanism, and the second engagement mechanism are arranged coaxially with one another. One side in an axial direction is defined as an axial-direction first side, and another side in the axial direction is defined as an axial-direction second side. The first planetary gear mechanism is arranged on the axial-direction first side of the second planetary gear mechanism. The first engagement mechanism and the second engagement mechanism are arranged on the axial-direction second side of the second planetary gear mechanism.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a skeleton diagram of a vehicle drive device including a vehicle transmission according to a first embodiment;

FIG. 2 is a velocity diagram of a first planetary gear mechanism and a second planetary gear mechanism according to the first embodiment;

FIG. 3 is a sectional view illustrating one example of configurations of a first engagement mechanism and a second engagement mechanism;

FIG. 4 is a sectional view illustrating another example of configurations of the first engagement mechanism and the second engagement mechanism;

FIG. 5 is a skeleton diagram of a vehicle drive device including a vehicle transmission according to a second embodiment;

FIG. 6 is a skeleton diagram of a vehicle drive device including a vehicle transmission according to a third embodiment;

FIG. 7 is a velocity diagram of a first planetary gear mechanism and a second planetary gear mechanism according to the third embodiment;

FIG. 8 is a skeleton diagram of a vehicle drive device including a vehicle transmission according to a fourth embodiment;

FIG. 9 is a velocity diagram of a first planetary gear mechanism and a second planetary gear mechanism according to the fourth embodiment;

FIG. 10 is a skeleton diagram of a vehicle drive device including a vehicle transmission according to a fifth embodiment; and

FIG. 11 is a velocity diagram of a first planetary gear mechanism and a second planetary gear mechanism according to the fifth embodiment.

### DETAILED DESCRIPTION

### 1. First Embodiment

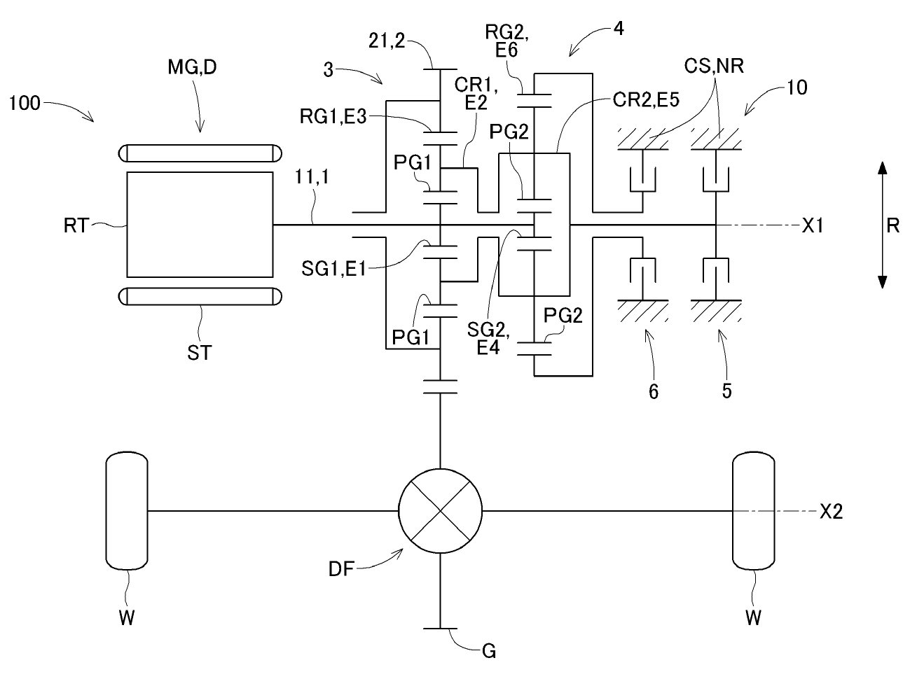

The following describes a vehicle transmission 10 according to a first embodiment, with reference to FIG. 1 to FIG. 3. The vehicle transmission 10 is provided in a vehicle drive device 100.

As illustrated in FIG. 1, in this embodiment, the vehicle drive device 100 includes a rotating electric machine MG, a differential gear mechanism DF, and a case CS.

The rotating electric machine MG functions both as a motor (electric motor) that receives supplied electric power to generate mechanical power, and as a generator (electric power generator) that receives supplied mechanical power to generate electric power. The rotating electric machine MG includes a stator ST and a rotor RT. The stator ST is fixed to a non-rotating member NR (in this example, the case CS). The rotor RT is supported in such a way as to be rotatable relative to the stator ST.

The differential gear mechanism DF is configured in such a way as to distribute, to a pair of wheels W, rotation transmitted from a side of the rotating electric machine MG. The differential gear mechanism DF is arranged on a second axis X2 different from a first axis X1 that is the rotational axis of the rotor RT. The differential gear mechanism DF includes a differential input gear G.

The case CS accommodates the vehicle transmission 10, the rotating electric machine MG, and the differential gear mechanism DF.

The vehicle transmission 10 includes an input member 1, an output member 2, a first planetary gear mechanism 3, a second planetary gear mechanism 4, a first engagement mechanism 5, and a second engagement mechanism 6.

The input member 1 is a member drive-connected to a drive source D. In this embodiment, the drive source D is the rotating electric machine MG.

In this disclosure, the term "drive-connected" refers to a state where two rotating elements are connected to each other in such a way as to allow drive force to be transmitted between the two rotating elements, and encompasses a state where the two rotating elements are coupled to each other in such a way as to rotate integrally with each other and a state where the two rotating elements are connected to each other via one or more transmission members in such a way as to allow drive force to be transmitted between the two rotating elements. Examples of the transmission member include various members each transmitting rotation at the same rotational speed or while changing a rotational speed, and specifically include a shaft, a gear mechanism, a belt, and a chain. Examples of the transmission member may also include an engagement device selectively transmitting rotation and drive force, and specifically include a friction engagement device and a meshing engagement device. However, when used for respective rotating elements constituting a planetary gear mechanism, the term "drive-connected" refers to a state where the rotating elements are drive-connected to each other via no other rotating elements.

In the following description, a direction along the first axis X1 is referred to as “axial direction L”. One side in the axial direction L is referred to as “axial-direction first side L1”, and an opposite side in the axial direction L is referred to as “axial-direction second side L2”. A direction perpendicular to the first axis X1 is referred to as the "radial direction R."

In this embodiment, the input member 1 is an input shaft 11 coupled to the rotor RT in such a way as to rotate integrally with the rotor RT. The input shaft 11 is a shaft member formed in such a way as to extend along the axial direction L. The input shaft 11 is arranged on the first axis X1.

The output member 2 is a member that is drive-connected to the wheels W. In this embodiment, the output member 2 is an output gear 21 including external teeth. The output gear 21 meshes with the differential input gear G. The output gear 21 is arranged on the first axis X1.

The first planetary gear mechanism 3, the second planetary gear mechanism 4, the first engagement mechanism 5, and the second engagement mechanism 6 are arranged on the first axis X1. In other words, the first planetary gear mechanism 3, the second planetary gear mechanism 4, the first engagement mechanism 5, and the second engagement mechanism 6 are arranged coaxially with one another.

The first planetary gear mechanism 3 is arranged on an axial-direction first side L1 of the second planetary gear mechanism 4. In this embodiment, the rotating electric machine MG is arranged on an axial-direction first side L1 of the first planetary gear mechanism 3.

The first engagement mechanism 5 and the second engagement mechanism 6 are arranged on an axial-direction second side L2 of the second planetary gear mechanism 4. In this embodiment, the first engagement mechanism 5 and the second engagement mechanism 6 are arranged in the axial direction L.

The first planetary gear mechanism 3 is a planetary gear mechanism including a first rotating element E1, a second rotating element E2, and a third rotating element E3. In this embodiment, the first planetary gear mechanism 3 is configured in such a way that the order of rotational speeds of the first rotating element E1, the second rotating element E2, and the third rotating element E3 corresponds to this mentioned order.

The second planetary gear mechanism 4 is a planetary gear mechanism including a fourth rotating element E4, a fifth rotating element E5, and a sixth rotating element E6. In this embodiment, the second planetary gear mechanism 4 is configured in such a way that the order of rotational speeds of the fourth rotating element E4, the fifth rotating element E5, and the sixth rotating element E6 corresponds to this mentioned order.

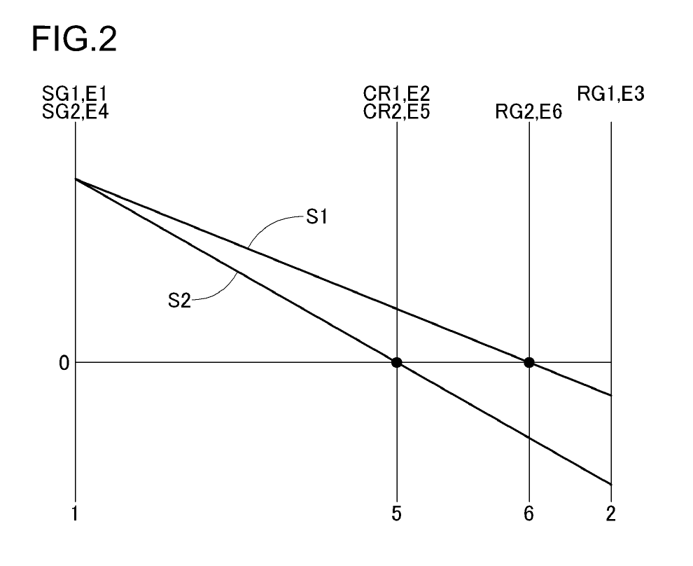

Here, the term "the order of rotational speeds" refers to a ranking of rotational speeds in a rotating state in which the respective rotating elements are rotating. Rotational speeds of the respective rotating elements vary depending on a state of the planetary gear mechanism. However, the highest-to-lowest order of rotational speeds of the respective rotating elements is determined by a structure of the planetary gear mechanism, and thus remains constant. The order of rotational speeds of the respective rotating elements is the same as the arrangement order of the respective rotating elements in a velocity diagram (refer to FIG. 2). Here, the term "the arrangement order of the respective rotating elements in the velocity diagram" refers to the order in which the axes corresponding to the respective rotating elements in the velocity diagram are arranged along a direction perpendicular to these axes. An arrangement direction of the axes corresponding to the respective rotating elements in the velocity diagram varies depending on how the velocity diagram is drawn. However, the arrangement order of the axes is determined by the structure of the planetary gear mechanism, and thus remains constant.

The first rotating element E1 is coupled to the input member 1 in such a way as to rotate integrally with the input member 1. The third rotating element E3 is coupled to the output member 2 in such a way as to rotate integrally with the output member 2.

In this embodiment, the first rotating element E1 is a first sun gear SG1. The second rotating element E2 is a first carrier CR1. The third rotating element E3 is a first ring gear RG1 including internal teeth. In this embodiment, the output gear 21 including the external teeth is arranged at a position that is on a radial-direction outer side of the third rotating element E3 as the first ring gear RG1 including the internal teeth and that overlaps with the third rotating element E3 when viewed in the radial direction R.

Here, concerning arrangement of two elements, the term "overlapping when viewed in a specific direction" indicates that an area where an imaginary line parallel to the specific direction intersects with both of the two elements exists in at least one part when the imaginary line is moved in each direction perpendicular to the imaginary line.

In this embodiment, the first planetary gear mechanism 3 is a single-pinion planetary gear mechanism. Thus, the first carrier CR1 rotatably supports a first pinion gear PG1 that meshes with both the first sun gear SG1 and the first ring gear RG1. The first pinion gear PG1 rotates around the axis (rotates on its own axis), and also rotates (revolves) around the first axis X1 together with the first carrier CR1.

The fourth rotating element E4 is coupled to the first rotating element E1 in such a way as to rotate integrally with the first rotating element E1. The fifth rotating element E5 is coupled to the second rotating element E2 or the third rotating element E3 in such a way as to rotate integrally with the second rotating element E2 or the third rotating element E3. In this embodiment, the fifth rotating element E5 is coupled to the second rotating element E2 in such a way as to rotate integrally with the second rotating element E2.

In this embodiment, the fourth rotating element E4 is a second sun gear SG2. The fifth rotating element E5 is a second carrier CRb. The sixth rotating element E6 is a second ring gear RG2 including internal teeth.

In this embodiment, the second planetary gear mechanism 4 is a single-pinion planetary gear mechanism. Thus, the second carrier CR2 rotatably supports the second pinion gear PG2 that meshes with both the second sun gear SG2 and the second ring gear RG2. The second pinion gear PG2 rotates around the axis (rotates on its own axis), and also rotates (revolves) around the first axis X1 together with the second carrier CR2.

The first engagement mechanism 5 is configured to be switchable between an engaged state in which the second rotating element E2 is locked to the non-rotating member NR and a released state in which the second rotating element E2 is rotatable. In this embodiment, the fifth rotating element E5 coupled to the second rotating element E2 in such a way as to rotate integrally with the second rotating element E2 is selectively locked to the non-rotating member NR. Thereby, the first engagement mechanism 5 is switched between the engaged state and the released state.

The second engagement mechanism 6 is configured to be switchable between an engaged state in which the sixth rotating element E6 is locked to the non-rotating member NR and a released state in which the sixth rotating element E6 is rotatable.

FIG. 2 is the velocity diagram of the first planetary gear mechanism 3 and the second planetary gear mechanism 4 according to this embodiment. In the velocity diagram of FIG. 2, the vertical lines correspond to rotational speeds of the respective rotating elements of the first planetary gear mechanism 3 and the second planetary gear mechanism 4. The reference signs indicated above a plurality of the vertical lines are signs of the corresponding rotating elements of the first planetary gear mechanism 3 and the second planetary gear mechanism 4. The reference signs indicated below a plurality of the vertical lines are signs of the elements drive-connected to the rotating elements corresponding to the signs indicated above. The same notation described above applies to velocity diagrams other than FIG. 2.

As illustrated in FIG. 2, when the first engagement mechanism 5 is in the released state and the second engagement mechanism 6 is in the engaged state, the second rotating element E2 (in this example, the first carrier CR1) is rotatable and the sixth rotating element E6 (in this example, the second ring gear RG2) is locked to the non-rotating member NR. Thus, a first gear shift stage S1 is formed. When the first gear shift stage S1 is formed, the rotation transmitted from the input member 1 to the first rotating element E1 (in this example, the first sun gear SG1) is reduced in speed at a relatively large reduction ratio in each of the first planetary gear mechanism 3 and the second planetary gear mechanism 4, and is output from the third rotating element E3 (in this example, the first ring gear RG1) to the output member 2.

At this time, in this embodiment, the second rotating element E2 (in this example, the first carrier CR1) and the third rotating element E3 (in this example, the first ring gear RG1) rotate in opposite directions. In other words, in this embodiment, the first planetary gear mechanism 3 and the second planetary gear mechanism 4 are configured in such a way that rotational directions of the second rotating element E2 and the third rotating element E3 are opposite to each other when the first engagement mechanism 5 is in the released state, the second engagement mechanism 6 is in the engaged state, and the input member 1 is rotating.

When the first engagement mechanism 5 is in the engaged state and the second engagement mechanism 6 is in the released state, the second rotating element E2 (in this example, the first carrier CR1) is locked to the non-rotating member NR and the sixth rotating element E6 (in this example, the second ring gear RG2) is rotatable. Thus, a second gear shift stage S2 is formed. When the second gear shift stage S2 is formed, the rotation transmitted from the input member 1 to the first rotating element E1 (in this example, the first sun gear SG1) is reduced in speed at a relatively small reduction ratio in the first planetary gear mechanism 3, and is output from the third rotating element E3 (in this example, the first ring gear RG1) to the output member 2.

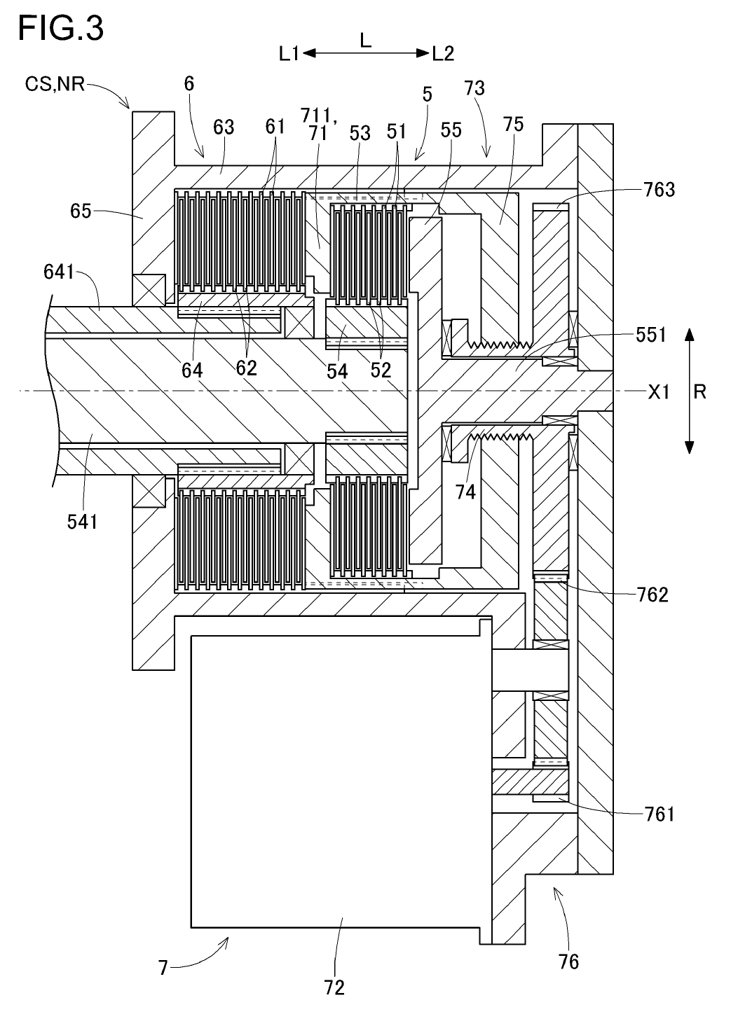

FIG. 3 is a sectional view illustrating one example of configurations of the first engagement mechanism 5 and the second engagement mechanism 6. As illustrated in FIG. 3, in this embodiment, the first engagement mechanism 5 is arranged on an axial-direction second side L2 of the second engagement mechanism 6. The first engagement mechanism 5 includes a first engagement element 51, a second engagement element 52, a first support member 53, and a second support member 54. The second engagement mechanism 6 includes a third engagement element 61, a fourth engagement element 62, a third support member 63, and a fourth support member 64.

The first engagement element 51 and the second engagement element 52 are configured in such a way as to engage with each other. The first support member 53 is a member supporting the first engagement element 51. The second support member 54 is a member supporting the second engagement element 52.

The third engagement element 61 and the fourth engagement element 62 are configured in such a way as to engage with each other. The third support member 63 is a member supporting the third engagement element 61. The fourth support member 64 is a member supporting the fourth engagement element 62.

In this embodiment, the first engagement element 51 and the second engagement element 52 are arranged to face each other in the axial direction L. The first engagement element 51 and the second engagement element 52 frictionally engage with each other when pressed to each other in the axial direction L. A plurality of the first engagement elements 51 and a plurality of the second engagement elements 52 are provided to be arranged alternately along the axial direction L.

In this embodiment, the third engagement element 61 and the fourth engagement element 62 are arranged to face each other in the axial direction L. The third engagement element 61 and the fourth engagement element 62 frictionally engage with each other when pressed to each other in the axial direction L. A plurality of the third engagement elements 61 and a plurality of the fourth engagement elements 62 are provided to be arranged alternately along the axial direction L.

Thus, in this embodiment, the first engagement mechanism 5 and the second engagement mechanism 6 are each a friction engagement mechanism. The friction engagement mechanism is configured in such a way that the engagement states (the engaged state and the released state) are each controlled depending on the engagement pressure between a pair of the engagement elements. In the friction engagement mechanism, the engaged state includes "direct engaged state" and "slip engaged state". The direct engaged state is a state in which a pair of the engagement elements engage with each other without differential rotation between the engagement elements. The slip engaged state is a state in which a pair of the engagement elements engage with each other while differential rotation occurs between the engagement elements.

In this embodiment, the first support member 53 supports the first engagement element 51 in such a way that the first engagement element 51 is non-rotatable and is slidable in the axial direction L. The first support member 53 is formed in a cylindrical shape whose axis is the first axis X1. The first support member 53 supports the first engagement element 51 from an outer side in the radial direction R. In the illustrated example, a plurality of spline teeth extending in the axial direction L are formed at an inner peripheral portion of the first support member 53 in such a way as to be distributed in the circumferential direction. Meanwhile, the similar spline teeth are formed also at an outer peripheral portion of the first engagement element 51 in such a way as to be distributed in the circumferential direction. These spline teeth engage with one another.

In this embodiment, the first support member 53 is supported by the case CS serving as the non-rotating member NR, in such a way as to be non-rotatable relative to the case CS and to be slidable in the axial direction L. In the illustrated example, a plurality of spline teeth extending in the axial direction are formed at an outer periphery of the first support member 53 in such a way as to be distributed in the circumferential direction. Meanwhile, the similar spline teeth are formed also at an inner peripheral portion of the case CS in such a way as to be distributed in the circumferential direction. These spline teeth engage with one another.

In this embodiment, the second support member 54 supports the second engagement element 52 in such a way that the second engagement element 52 is slidable in the axial direction L and the second support member 54 rotates integrally with the second engagement element 52. The second support member 54 is formed into a cylindrical shape whose axis is the first axis X1. The second support member 54 supports the second engagement element 52 from an inner side in the radial direction R. In the illustrated example, a plurality of spline teeth extending in the axial direction L are formed at an outer peripheral portion of the second support member 54 in such a way as to be distributed in the circumferential direction. Meanwhile, the similar spline teeth are formed also at an inner peripheral portion of the second engagement element 52 in such a way as to be distributed in the circumferential direction. These spline teeth engage with one another.

In this embodiment, the second support member 54 is coupled to the second carrier CR2 serving as fifth rotating element E5, via a first shaft member 541, in such a way as to rotate integrally with the second carrier CR2. The first shaft member 541 is formed to extend along the axial direction L.

In this embodiment, the third support member 63 supports the third engagement element 61 in such a way as to be non-rotatable relative to the case CS and be slidable in the axial direction L. The third support member 63 is formed into a cylindrical shape whose axis is the first axis X1. The third support member 63 supports the third engagement element 61 from an outer side in the radial direction R. In the illustrated example, a plurality of spline teeth extending in the axial direction L are formed at an inner peripheral portion of the third support member 63 in such a way as to be distributed in the circumferential direction. Meanwhile, the similar spline teeth are formed also at an outer peripheral portion of the third engagement element 61 in such a way as to be distributed in the circumferential direction. These spline teeth engage with one another.

In this embodiment, the third support member 63 is supported by the case CS serving as the non-rotating member NR, in such a way as to be non-rotatable relative to the case CS and be slidable in the axial direction L. In the illustrated example, the third support member 63 is formed integrally with the case CS.

In this embodiment, the fourth support member 64 supports the fourth engagement element 62 in such a way that the fourth engagement element 62 is slidable in the axial direction L and the fourth support member 64 rotates integrally with the fourth engagement element 62. The fourth support member 64 is formed into a cylindrical shape whose axis is the first axis X1. The fourth support member 64 supports the fourth engagement element 62 from an inner side in the radial direction R. In the illustrated example, a plurality of spline teeth extending in the axial direction L are formed at an outer peripheral portion of the fourth support member 64 in such a way as to be distributed in the circumferential direction. Meanwhile, the similar spline teeth are formed also at an inner peripheral portion of the fourth engagement element 62 in such a way as to be distributed in the circumferential direction. These spline teeth engage with one another.

In this embodiment, the fourth support member 64 is coupled to the second ring gear RG2 serving as the sixth rotating element E6, via a second shaft member 641, in such a way as to rotate integrally with the second ring gear RG2. The second shaft member 641 is formed to extend along the axial direction L.

Here, as described above, the first gear shift stage S1 is formed when the first engagement mechanism 5 is in the released state and the second engagement mechanism 6 is in the engaged state. The second gear shift stage S2 is formed when the first engagement mechanism 5 is in the engaged state and the second engagement mechanism 6 is in the released state. Since the first gear shift stage S1 has a reduction ratio larger than that of the second gear shift stage S2, the engagement torque of the second engagement mechanism 6 for forming the first gear shift stage S1 needs to be larger than the engagement torque of the first engagement mechanism 5 for forming the second gear shift stage S2. In view of it, in this embodiment, the second shaft member 641 is formed into a cylindrical shape whose axis is the first axis X1, and is arranged in such a way as to cover the first shaft member 541 from an outer side in the radial direction R. This configuration increases strength of the second shaft member 641 coupled to the fourth support member 64 of the second engagement mechanism 6 whose engagement torque for forming the first gear shift stage S1 is relatively large.

In this embodiment, the first engagement mechanism 5 further includes a first pressure reception member 55. The first pressure reception member 55 is a member supporting the first engagement element 51 and the second engagement element 52 in the axial direction L when the first engagement element 51 and the second engagement element 52 are pressed to each other in the axial direction L. In this embodiment, the first pressure reception member 55 is arranged on an axial-direction second side L2 of the first engagement element 51 and the second engagement element 52. In the illustrated example, the first pressure reception member 55 is formed in an annular shape whose axis is the first axis X1. The first pressure reception member 55 is fixed to the case CS via a support shaft member 551 formed to extend along the axial direction L.

In this embodiment, the second engagement mechanism 6 further includes a second pressure reception member 65. The second pressure reception member 65 is a member supporting the third engagement element 61 and the fourth engagement element 62 in the axial direction L when the third engagement element 61 and the fourth engagement element 62 are pressed to each other in the axial direction L. In this embodiment, the second pressure reception member 65 is arranged on an axial-direction first side L1 of the third engagement element 61 and the fourth engagement element 62. In the illustrated example, the second pressure reception member 65 is formed into an annular shape whose axis is the first axis X1. The second pressure reception member 65 is formed integrally with the case CS.

As illustrated in FIG. 3, in this embodiment, the vehicle transmission 10 further includes a drive mechanism 7. The drive mechanism 7 is configured to drive both the first engagement mechanism 5 and the second engagement mechanism 6. In other words, the first engagement mechanism 5 and the second engagement mechanism 6 are driven by the common drive mechanism 7.

The drive mechanism 7 includes an engagement member 71 and a drive device 72. In this embodiment, the drive mechanism 7 further includes a linear motion conversion mechanism 73.

The engagement member 71 is a member that operates in such a way as to selectively cause one of the first engagement mechanism 5 and the second engagement mechanism 6 to be brought into the engagement state. In this embodiment, the engagement member 71 is coupled to the first support member 53 in such a way as to move integrally with the first support member 53 in the axial direction L. The engagement member 71 includes a pressing portion 711. The pressing portion 711 presses the first engagement element 51 and the second engagement element 52 to an axial-direction second side L2, and presses the third engagement element 61 and the fourth engagement element 62 to an axial-direction first side L1.

The drive device 72 is configured to output drive force for moving the engagement member 71 in the axial direction L. In this embodiment, the drive device 72 is an electric motor that outputs predetermined rotational drive force.

The linear motion conversion mechanism 73 includes a screw shaft 74, a nut member 75, and a transmission mechanism 76.

The screw shaft 74 is formed in a cylindrical shape extending along the axial direction L. The screw shaft 74 includes an outer circumferential portion on which a screw thread is formed. The screw shaft 74 is supported in such a way as to be rotatable relative to the non-rotating member NR. In this embodiment, the screw shaft 74 is arranged on the first axis X1 in such a way as to cover the support shaft member 551 from an outer side in the radial direction R. The screw shaft 74 is supported in such a way as to be rotatable relative to the support shaft member 551.

The nut member 75 is configured to be screwed onto the screw shaft 74. In other words, the nut member 75 includes an inner circumferential portion on which a groove engaging with the screw thread of the screw shaft 74 is formed. The nut member 75 is supported in such a way as to be non-rotatable relative to the non-rotating member NR and to be movable relative to the non-rotating member NR in the axial direction L. In this embodiment, the nut member 75 is coupled to the first support member 53 in such a way as to move integrally with the first support member 53 in the axial direction L. In other words, in this embodiment, the nut member 75 is supported via the first support member 53 by the case CS serving as the non-rotating member NR, in such a way as to be non-rotatable relative to the case CS and to be movable relative to the case CS in the axial direction L. Thus, rotation of the screw shaft 74 causes the nut member 75 to linearly move along the axial direction L, depending on a direction of the rotation and a direction of the screw thread of the screw shaft 74.

The transmission mechanism 76 is configured to transmit, to the screw shaft 74, rotational drive force of the drive device 72 that is the electric motor. In this embodiment, the transmission mechanism 76 includes a first transmission gear 761, a second transmission gear 762, and a third transmission gear 763.

The first transmission gear 761 is coupled to an output element of the drive device 72 as the electric motor, in such a way as to rotate integrally with this output element.

The second transmission gear 762 meshes with the first transmission gear 761. The second transmission gear 762 is an idler gear supported in such a way as to be rotatable relative to the case CS.

The third transmission gear 763 meshes with the second transmission gear 762. The third transmission gear 763 is coupled to the screw shaft 74 in such a way as to rotate integrally with the screw shaft 74.

In this embodiment, the number of teeth of the third transmission gear 763 is larger than the number of teeth of the first transmission gear 761. Accordingly, in this embodiment, the rotation transmitted from the drive device 72 to the first transmission gear 761 is reduced in speed between the first transmission gear 761 and the third transmission gear 763 connected to each other via the second transmission gear 762, and is transmitted to the screw shaft 74. In other words, in this embodiment, the transmission mechanism 76 is configured to decelerate the rotation of the drive device 72 and transmit the decelerated rotation to the screw shaft 74.

In this embodiment, when the drive device 72 drives the rotation in a first direction, the rotational drive force of the drive device 72 is transmitted to the screw shaft 74 via the transmission mechanism 76. Thereby, the nut member 75 moves to an axial-direction second side L2. Accordingly, the engagement member 71 moves to an axial-direction second side L2 via the first support member 53 coupled to the nut member 75. As a result, the first engagement element 51 and the second engagement element 52 are pressed to each other in the axial direction L between the pressing portion 711 of the engagement member 71 and the first pressure reception member 55. Thereby, the first engagement mechanism 5 is brought into the engaged state, while mutual pressing of the third engagement element 61 and the fourth engagement element 62 between the pressing portion 711 and the second pressure reception member 65 is released to bring the second engagement mechanism 6 into the released state.

Meanwhile, when the drive device 72 drives the rotation in a second direction opposite to the first direction, the rotational drive force of the drive device 72 is transmitted to the screw shaft 74 via the transmission mechanism 76. Thereby, the nut member 75 moves to an axial-direction first side L1. Accordingly, the engagement member 71 moves to an axial-direction first side L1 via the first support member 53 coupled to the nut member 75. As a result, the third engagement element 61 and the fourth engagement element 62 are pressed to each other in the axial direction L between the pressing portion 711 of the engagement member 71 and the second pressure reception member 65. Thereby, the second engagement mechanism 6 is brought into the engaged state, while mutual pressing of the first engagement element 51 and the second engagement element 52 between the pressing portion 711 and the first pressure reception member 55 is released to bring the first engagement mechanism 5 into the released state.

Thus, in this embodiment, the drive force of the drive device 72 drives the engagement member 71 to one side in the axial direction L. Thereby, the first engagement mechanism 5 is brought into the engaged state, and the second engagement mechanism 6 is brought into the released state. The drive force of the drive device 72 drives the engagement member 71 to the other side in the axial direction L. Thereby, the first engagement mechanism 5 is brought into the released state, and the second engagement mechanism 6 is brought into the engaged state.

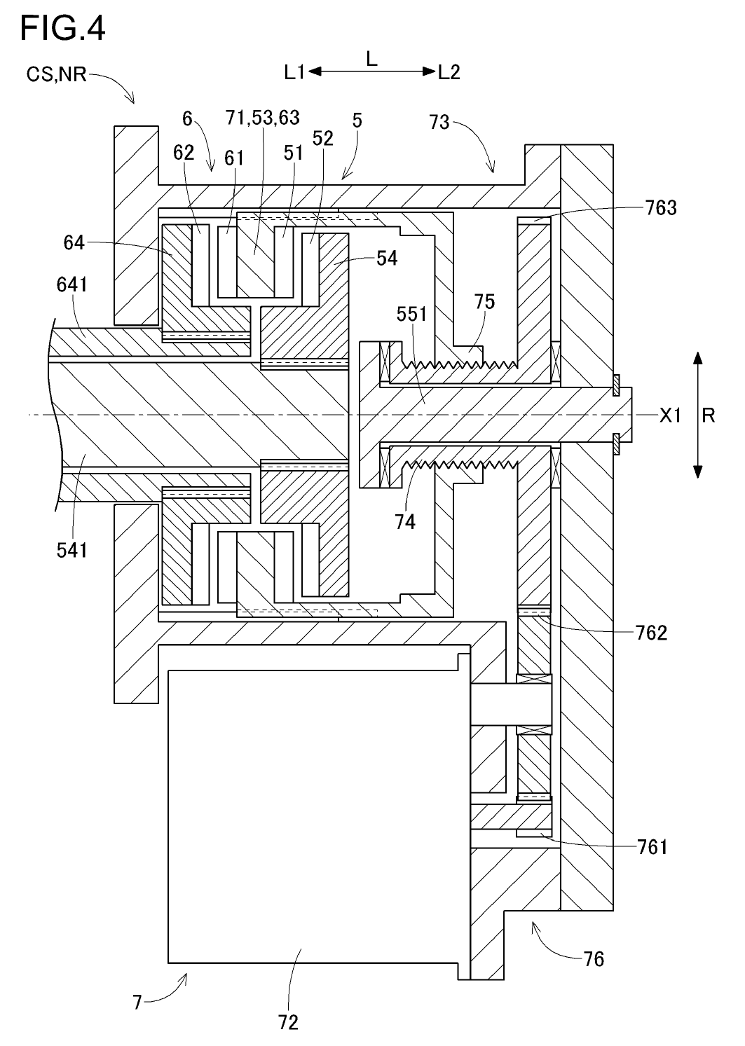

In the exemplified configuration described above in the embodiment, the first engagement mechanism 5 and the second engagement mechanism 6 are each a friction engagement mechanism. However, this disclosure is not limited to such a configuration. For example, as illustrated in FIG. 4, the first engagement mechanism 5 and the second engagement mechanism 6 may be each an interlocking engagement mechanism.

In the example illustrated in FIG. 4, the first engagement element 51 and the second engagement element 52 are formed in such a way as to interlock with each other. In this example, the engagement member 71 does not include the pressing portion 711, and instead, is formed integrally with the first support member 53 supporting the first engagement element 51, and is formed integrally with the third support member 63 supporting the third engagement element 61. The first engagement element 51 is arranged on an axial-direction second side L2 of the engagement member 71, and the third engagement element 61 is arranged on an axial-direction first side L1 of the engagement member 71.

In this example, the first engagement mechanism 5 does not include the first pressure reception member 55. The second engagement mechanism 6 does not include the second pressure reception member 65.

### 2. Second Embodiment

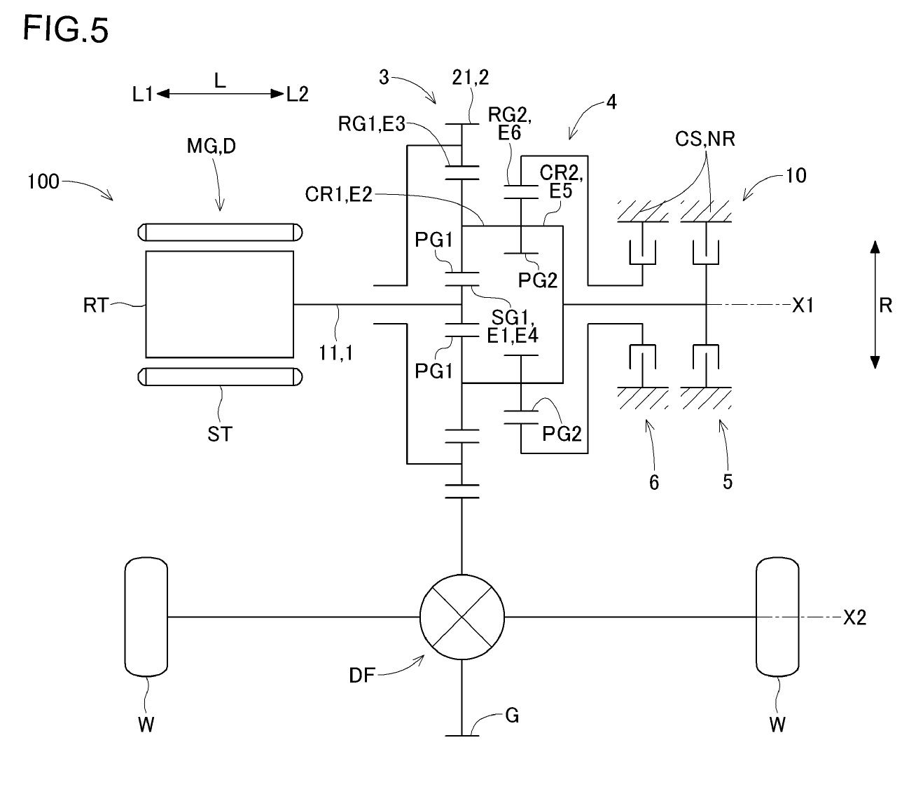

With reference to FIG. 5, the following describes the vehicle drive device 100 including the vehicle transmission 10 according to a second embodiment. In this embodiment, configurations of the first planetary gear mechanism 3 and the second planetary gear mechanism 4 differ from those in the first embodiment. The following mainly describes the matters different from those in the first embodiment. The matters that are not specifically described are equivalent to those in the first embodiment.

As illustrated in FIG. 5, in this embodiment, the first rotating element E1 and the fourth rotating element E4 are configured integrally with each other. Thus, in this embodiment, the second sun gear SG2 is not provided, and the first sun gear SG1 functions as the first rotating element E1 and the fourth rotating element E4.

In this embodiment, the first pinion gear PG1 and the second pinion gear PG2 are coupled to each other in such a way as to rotate integrally with each other. The first pinion gear PG1 has a diameter larger than that of the second pinion gear PG2.

In this embodiment, similarly to the first embodiment described above, when the first gear shift stage S1 is formed, the rotation transmitted from the input member 1 to the first rotating element E1 is reduced in speed at a relatively large reduction ratio in each of the first planetary gear mechanism 3 and the second planetary gear mechanism 4, and is output from the third rotating element E3 to the output member 2. When the second gear shift stage S2 is formed, the rotation transmitted from the input member 1 to the first rotating element E1 is reduced in speed at a relatively small reduction ratio in the first planetary gear mechanism 3, and is output from the third rotating element E3 to the output member 2.

### 3. Third Embodiment

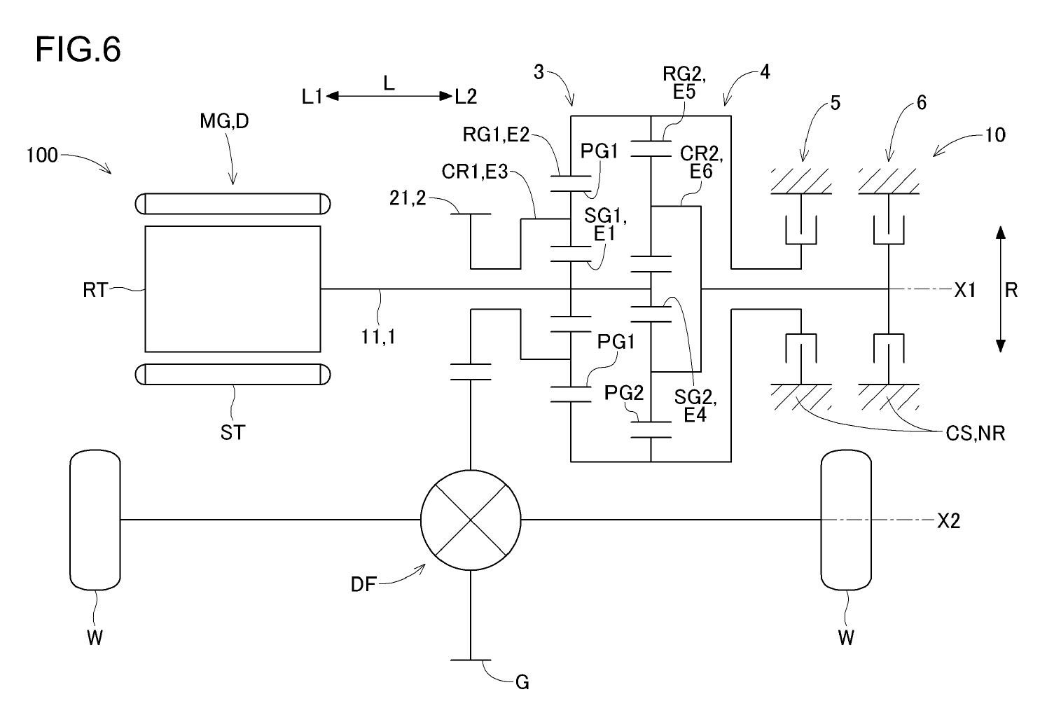

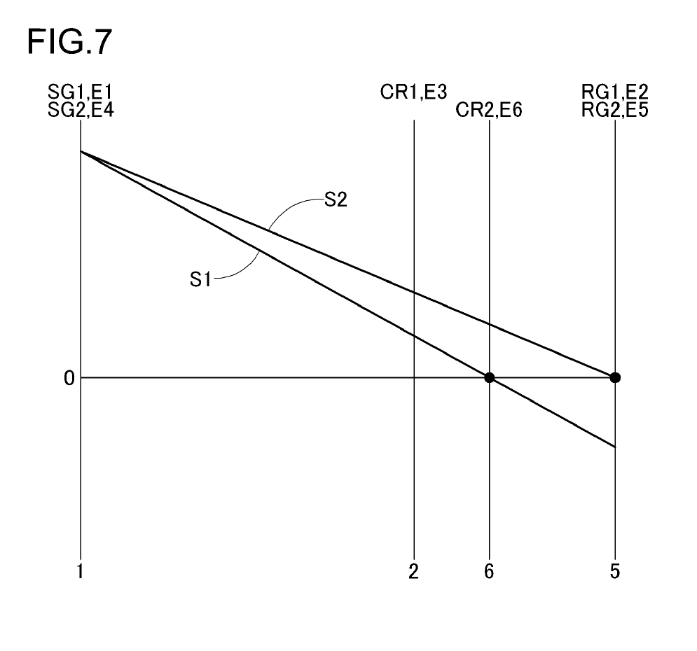

With reference to FIG. 6 and FIG. 7, the following describes the vehicle drive device 100 including the vehicle transmission 10 according to a third embodiment. In this embodiment, a position of the output member 2, positions of the first engagement mechanism 5 and the second engagement mechanism 6, and configurations of the first planetary gear mechanism 3 and the second planetary gear mechanism 4 differ from those in the first embodiment described above. The following mainly describes the matters different from those in the first embodiment. The matters that are not specifically described are equivalent to those in the first embodiment.

As illustrated in FIG. 6, in this embodiment, the output gear 21 serving as the output member 2 is arranged on an axial-direction first side L1 of the first planetary gear mechanism 3. The output gear 21 is coupled to the first carrier CR1 in such a way as to rotate integrally with the first carrier CR1.

In this embodiment, the first engagement mechanism 5 is arranged on an axial-direction first side L1 of the second engagement mechanism 6.

In this embodiment, the first rotating element E1 is the first sun gear SG1. The second rotating element E2 is the first ring gear RG1. The third rotating element E3 is the first carrier CR1.

In this embodiment, the fourth rotating element E4 is the second sun gear SG2. The fifth rotating element E5 is the second ring gear RG2. The sixth rotating element E6 is the second carrier CR2.

In this embodiment, the first carrier CR1 is coupled to the output member 2 in such a way as to rotate integrally with the output member 2. The first ring gear RG1 and the second ring gear RG2 are coupled to each other in such a way as to rotate integrally with each other. The first ring gear RG1 and the second ring gear RG2 are coupled to the first engagement mechanism 5. The second carrier CR2 is coupled to the second engagement mechanism 6.

As illustrated in FIG. 7, in this embodiment, the first planetary gear mechanism 3 is configured in such a way that the order of rotational speeds of the first rotating element E1, the third rotating element E3, and the second rotating element E2 corresponds to this mentioned order. The second planetary gear mechanism 4 is configured in such a way that the order of rotational speeds of the fourth rotating element E4, the sixth rotating element E6, and the fifth rotating element E5 corresponds to this mentioned order.

### 4. Fourth Embodiment

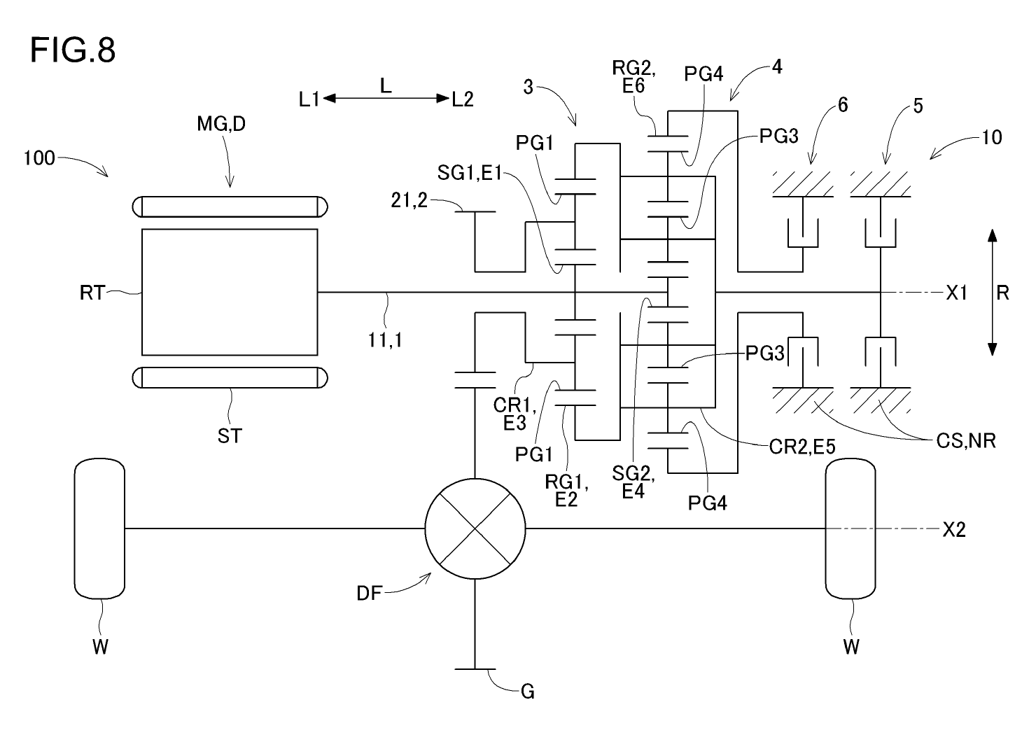

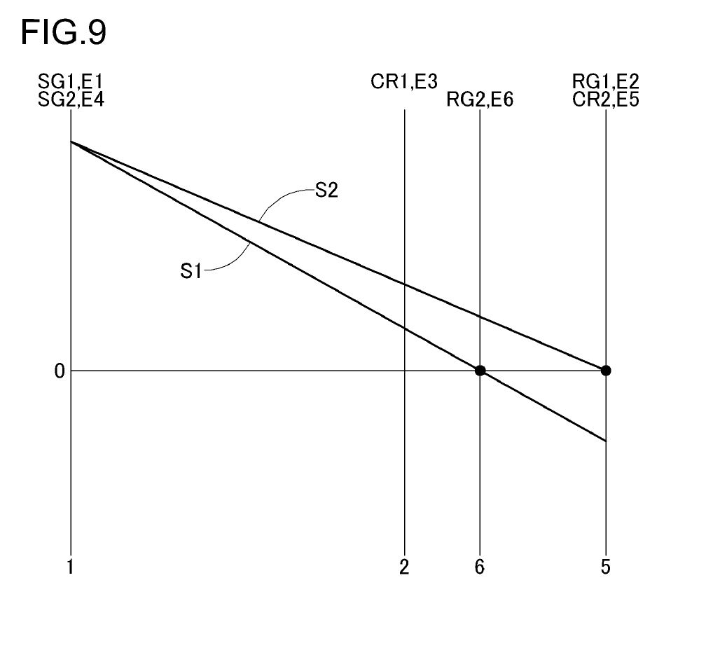

With reference to FIG. 8 and FIG. 9, the following describes the vehicle drive device 100 including the vehicle transmission 10 according to a fourth embodiment. In this embodiment, a position of the output member 2 and configurations of the first planetary gear mechanism 3 and the second planetary gear mechanism 4 differ from those in the first embodiment. The following mainly describes the matters different from those in the first embodiment. The matters that are not specifically described are equivalent to those in the first embodiment.

As illustrated in FIG. 8, in this embodiment, the output gear 21 serving as the output member 2 is arranged on an axial-direction first side L1 of the first planetary gear mechanism 3. The output gear 21 is coupled to the first carrier CR1 in such a way as to rotate integrally with the first carrier CR1.

In this embodiment, the first rotating element E1 is the first sun gear SG1. The second rotating element E2 is the first ring gear RG1. The third rotating element E3 is the first carrier CR1.

In this embodiment, the fourth rotating element E4 is the second sun gear SG2. The fifth rotating element E5 is the second carrier CR2. The sixth rotating element E6 is the second ring gear RG2.

In this embodiment, the second planetary gear mechanism 4 is a double-pinion planetary gear mechanism. Thus, the second carrier CR2 rotatably supports a third pinion gear PG3 meshing with the second sun gear SG2, and rotatably supports a fourth pinion gear PG4 meshing with the third pinion gear PG3 and the second ring gear RG2.

In this embodiment, the first carrier CR1 is coupled to the output member 2 in such a way as to rotate integrally with the output member 2. The first ring gear RG1 and the second carrier CR2 are coupled to each other in such a way as to rotate integrally with each other. The first ring gear RG1 and the second carrier CR2 are coupled to the first engagement mechanism 5. The second ring gear RG2 is coupled to the second engagement mechanism 6.

As illustrated in FIG. 9, in this embodiment, the first planetary gear mechanism 3 is configured in such a way that the order of rotational speeds of the first rotating element E1, the third rotating element E3, and the second rotating element E2 corresponds to this mentioned order. The second planetary gear mechanism 4 is configured in such a way that the order of rotational speeds of the fourth rotating element E4, the sixth rotating element E6, and the fifth rotating element E5 corresponds to this mentioned order.

### 5. Fifth Embodiment

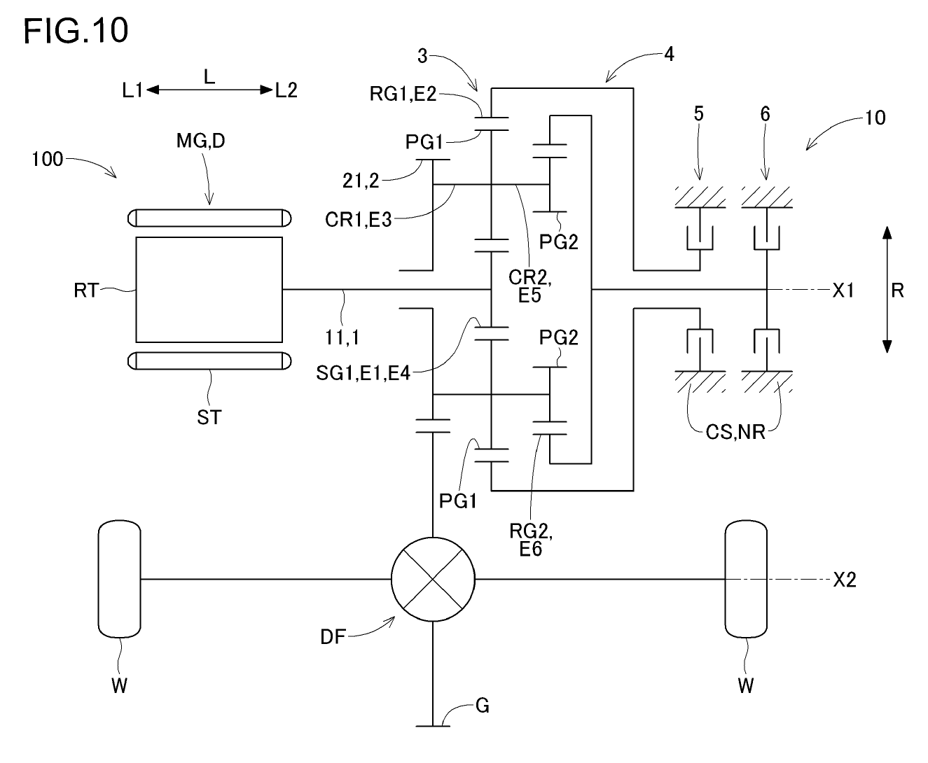

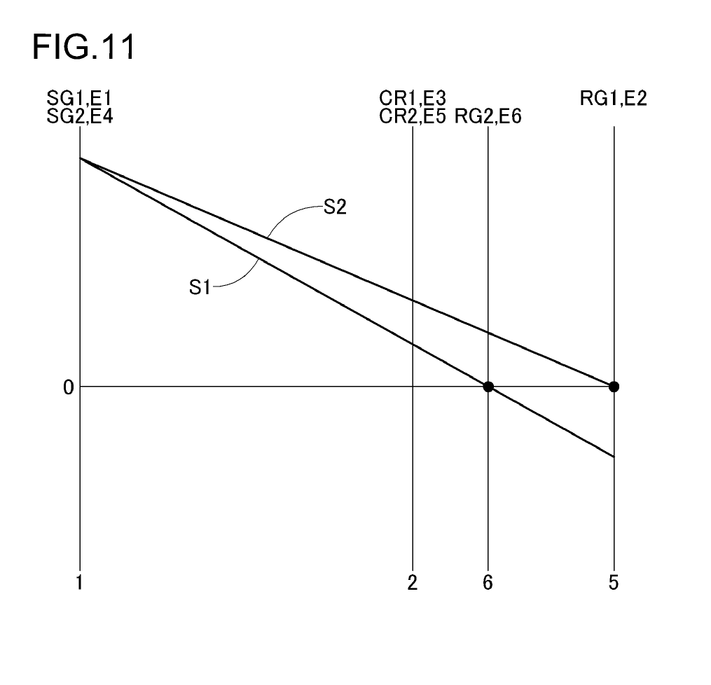

With reference to FIG. 10 and FIG. 11, the following describes the vehicle drive device 100 including the vehicle transmission 10 according to a fifth embodiment. In this embodiment, positions of the first engagement mechanism 5 and the second engagement mechanism 6 and configurations of the first planetary gear mechanism 3 and the second planetary gear mechanism 4 differ from those in the first embodiment. The following mainly describes the matters different from those in the first embodiment. The matters that are not specifically described are equivalent to those in the first embodiment.

As illustrated in FIG. 10, in this embodiment, the first engagement mechanism 5 is arranged on an axial-direction first side L1 of the second engagement mechanism 6.

In this embodiment, the fifth rotating element E5 is coupled to the third rotating element E3 in such a way as to rotate integrally with the third rotating element E3. As described above, in the first to fourth embodiments, the fifth rotating element E5 is coupled to the second rotating element E2 in such a way as to rotate integrally with the second rotating element E2. In other words, the fifth rotating element E5 is coupled to and rotates integrally with the second rotating element E2 or the third rotating element E3.

In this embodiment, the first rotating element E1 and the fourth rotating element E4 are configured integrally with each other. Thus, in this embodiment, the second sun gear SG2 is not provided, and the first sun gear SG1 functions as the first rotating element E1 and the fourth rotating element E4.

In this embodiment, the second rotating element E2 is the first ring gear RG1. The third rotating element E3 is the first carrier CR1. The fifth rotating element E5 is the second carrier CR2. The sixth rotating element E6 is the second ring gear RG2.

In this embodiment, the first pinion gear PG1 and the second pinion gear PG2 are coupled to each other in such a way as to rotate integrally with each other. The first pinion gear PG1 has a diameter larger than that of the second pinion gear PG2.

In this embodiment, the first carrier CR1 and the second carrier CR2 are coupled to the output member 2 in such a way as to rotate integrally with the output member 2. The first ring gear RG1 is coupled to the first engagement mechanism 5. The second ring gear RG2 is coupled to the second engagement mechanism 6.

As illustrated in FIG. 11, in this embodiment, the first planetary gear mechanism 3 is configured in such a way that the order of rotational speeds of the first rotating element E1, the third rotating element E3, and the second rotating element E2 corresponds to this mentioned order. The second planetary gear mechanism 4 is configured in such a way that the order of rotational speeds of the fourth rotating element E4, the fifth rotating element E5, and the sixth rotating element E6 corresponds to this mentioned order.

### 6. Other Embodiments

(1) In the configuration example described in each of the above embodiments, the vehicle drive device 100 includes the differential gear mechanism DF, and the differential gear mechanism DF includes the differential input gear G meshing with the output gear 21 serving as the output member 2. However, this disclosure is not limited to this configuration. For example, the vehicle drive device 100 may have a configuration in which the differential gear mechanism DF is not provided and the output member 2 is an output shaft rotating integrally with the wheels W.
(2) In the configuration example described in each of the above embodiments, the first engagement mechanism 5 and the second engagement mechanism 6 are driven by the common drive mechanism 7. However, this disclosure is not limited to this configuration, and the first engagement mechanism 5 and the second engagement mechanism 6 may be driven by mutually different drive mechanisms.
(3) The configuration disclosed in each of the above-described respective embodiments can be applied in combination with the configuration disclosed in each of the other embodiments, as long as no contradictions occur. The embodiments disclosed in this specification are merely illustrative in all respects, concerning the other configurations. Accordingly, various modifications can be made as appropriate within the essence of this disclosure.

### 7. Outline of Embodiments

The following describes an outline of the above-described vehicle transmission (10).

A vehicle transmission (10) according to this disclosure includes an input member (1), an output member (2), a first planetary gear mechanism (3), a second planetary gear mechanism (4), a first engagement mechanism (5), and a second engagement mechanism (6). The input member (1) is drive-connected to a drive source (D). The output member (2) is drive-connected to a wheel (W). The first planetary gear mechanism (3) includes a first rotating element (E1), a second rotating element (E2), and a third rotating element (E3). The second planetary gear mechanism (4) includes a fourth rotating element (E4), a fifth rotating element (E5), and a sixth rotating element (E6). The first rotating element (E1) is coupled to the input member (1) in such a way as to rotate integrally with the input member (1). The third rotating element (E3) is coupled to the output member (2) in such a way as to rotate integrally with the output member (2). The first rotating element (E1) and the fourth rotating element (E4) are coupled to each other in such a way as to rotate integrally with each other. The fifth rotating element (E5) is coupled to the second rotating element (E2) or the third rotating element (E3) in such a way as to rotate integrally with the second rotating element (E2) or the third rotating element (E3). The first engagement mechanism (5) is configured to be switchable between an engaged state in which the second rotating element (E2) is locked to a non-rotating member (NR) and a released state in which the second rotating element (E2) is rotatable. The second engagement mechanism (6) is configured to be switchable between an engaged state in which the sixth rotating element (E6) is locked to the non-rotating member (NR) and a released state in which the sixth rotating element (E6) is rotatable. The first planetary gear mechanism (3), the second planetary gear mechanism (4), the first engagement mechanism (5), and the second engagement mechanism (6) are arranged coaxially with one another. One side in an axial direction (L) is defined as an axial-direction first side (L1), and another side in the axial direction (L) is defined as an axial-direction second side (L2). The first planetary gear mechanism (3) is arranged on the axial-direction first side (L1) of the second planetary gear mechanism (4). The first engagement mechanism (5) and the second engagement mechanism (6) are arranged on the axial-direction second side (L2) of the second planetary gear mechanism (4).

According to this configuration, each of the first engagement mechanism (5) and the second engagement mechanism (6) for achieving two-stage gear shifting is configured as a brake that locks the rotating element to the non-rotating member (NR). Thereby, the power transmission structure in the engagement mechanisms can be more easily simplified and durability of the engagement mechanisms can be more easily secured than in a case where at least one of the first engagement mechanism (5) and the second engagement mechanism (6) is configured as a friction clutch that connects and disconnects power transmission between two rotating elements. Accordingly, the vehicle transmission (10) can be easily reduced in size while durability of the vehicle transmission (10) is secured.

According to this configuration, the first planetary gear mechanism (3), the second planetary gear mechanism (4), the first engagement mechanism (5), and the second engagement mechanism (6) are arranged coaxially with one another. Thereby, a size of the vehicle transmission (10) in the radial direction (R) can be easily reduced.

According to this configuration, the first planetary gear mechanism (3) is arranged on the axial-direction first side (L1) of the second planetary gear mechanism (4), and the first engagement mechanism (5) and the second engagement mechanism (6) are arranged on the axial-direction second side (L2) of the second planetary gear mechanism (4). Thereby, a configuration for connecting the first rotating element (E1) of the first planetary gear mechanism (3) to the input member (1) and for connecting the third rotating element (E3) of the first planetary gear mechanism (3) to the output member (2) can be easily simplified. Accordingly, the vehicle transmission (10) can be easily reduced in size.

The first planetary gear mechanism (3) and the second planetary gear mechanism (4) may be configured in such a way that the second rotating element (E2) and the third rotating element (E3) rotate in opposite directions in a state in which the first engagement mechanism (5) is in the released state, the second engagement mechanism (6) is in the engaged state, and the input member (1) is rotating.

According to this configuration, at the gear shift stage (S1) formed when the first engagement mechanism (5) is in the released state and the second engagement mechanism (6) is in the engaged state, rotation of the input member (1) can be reduced in speed at a large reduction ratio and transmitted to the output member (2).

The first engagement mechanism (5) and the second engagement mechanism (6) may be arranged in the axial direction (L) and driven by a common drive mechanism (7). The drive mechanism (7) may include an engagement member (71) and a drive device (72). The engagement member (71) may operate in such a way as to selectively cause one of the first engagement mechanism (5) and the second engagement mechanism (6) to be brought into the engaged state. The drive device (72) may output drive force for moving the engagement member (71) in the axial direction (L). The drive force of the drive device (72) may drive the engagement member (71) to one side in the axial direction (L). Thereby, the first engagement mechanism (5) may be brought into the engaged state, and the second engagement mechanism (6) may be brought into the released state. The drive force of the drive device (72) may drive the engagement member (71) to another side in the axial direction (L). Thereby, the first engagement mechanism (5) may be brought into the released state, and the second engagement mechanism (6) may be brought into the engaged state.

According to this configuration, the first engagement mechanism (5) and the second engagement mechanism (6) can be driven by the common drive mechanism (7). Thus, a size and cost of the vehicle transmission (10) can be easily reduced.

The first rotating element (E1) and the fourth rotating element (E4) may be sun gears (SG1, SG2). The second rotating element (E2) and the fifth rotating element (E5) may be carriers (CR1, CR2). The third rotating element (E3) and the sixth rotating element (E6) may be ring gears (RG1, RG2) including internal teeth. The output member (2) may be an output gear (21) including external teeth. The output gear (21) may be arranged at a position that is on an outer side of the third rotating element (E3) in a radial direction (R) and that overlaps with the third rotating element (E3) when viewed in the radial direction (R).

This configuration can achieve the vehicle transmission (10) in which a relatively large gear shift stage (S1) is made by a combination of the first planetary gear mechanism (3) and the second planetary gear mechanism (4), and a relatively small gear shift stage (S2) is made by the first planetary gear mechanism (3) alone.

Further, according to this configuration, the output member is the output gear (21) including the external teeth, and the third rotating element (E3) is the ring gear (RG1) including the internal teeth. The output gear (21) is arranged at a position that is on an outer side of the third rotating element (E3) in the radial direction (R) and that overlaps with the third rotating element (E3) when viewed in the radial direction (R). Thereby, a size of the vehicle transmission (10) in the axial direction (L) can be suppressed to be small.

### INDUSTRIAL APPLICABILITY

The technique disclosed herein can be applied to a vehicle transmission including an input member to be drive-connected to a drive source, an output member to be drive-connected to a wheel, a planetary gear mechanism, and an engagement mechanism.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle transmission comprising:
an input member to be drive-connected to a drive source;
an output member to be drive-connected to a wheel;
a first planetary gear mechanism that includes a first rotating element, a second rotating element, and a third rotating element;
a second planetary gear mechanism that includes a fourth rotating element, a fifth rotating element, and a sixth rotating element;
a first engagement mechanism; and
a second engagement mechanism, wherein
the first rotating element is coupled to the input member in such a way as to rotate integrally with the input member,
the third rotating element is coupled to the output member in such a way as to rotate integrally with the output member,
the first rotating element and the fourth rotating element are coupled to each other in such a way as to rotate integrally with each other,
the fifth rotating element is coupled to the second rotating element or the third rotating element in such a way as to rotate integrally with the second rotating element or the third rotating element,
the first engagement mechanism is configured to be switchable between an engaged state in which the second rotating element is locked to a non-rotating member and a released state in which the second rotating element is rotatable,
the second engagement mechanism is configured to be switchable between an engaged state in which the sixth rotating element is locked to the non-rotating member and a released state in which the sixth rotating element is rotatable,
the first planetary gear mechanism, the second planetary gear mechanism, the first engagement mechanism, and the second engagement mechanism are arranged coaxially with one another,
one side in an axial direction is defined as an axial-direction first side, and another side in the axial direction is defined as an axial-direction second side,
the first planetary gear mechanism is arranged on the axial-direction first side of the second planetary gear mechanism, and
the first engagement mechanism and the second engagement mechanism are arranged on the axial-direction second side of the second planetary gear mechanism.

2. The vehicle transmission according to claim 1, wherein
the first planetary gear mechanism and the second planetary gear mechanism are configured in such a way that the second rotating element and the third rotating element rotate in opposite directions in a state in which the first engagement mechanism is in the released state, the second engagement mechanism is in the engaged state, and the input member is rotating.

3. The vehicle transmission according to claim 1, wherein
the first engagement mechanism and the second engagement mechanism are arranged in the axial direction and driven by a common drive mechanism,
the drive mechanism includes an engagement member and a drive device, the engagement member operating in such a way as to selectively cause one of the first engagement mechanism and the second engagement mechanism to be brought into the engaged state, the drive device outputting drive force for moving the engagement member in the axial direction,
the drive force of the drive device drives the engagement member to one side in the axial direction, thereby bringing the first engagement mechanism into the engaged state, and bringing the second engagement mechanism into the released state, and
the drive force of the drive device drives the engagement member to another side in the axial direction, thereby bringing the first engagement mechanism into the released state, and bringing the second engagement mechanism into the engaged state.

4. The vehicle transmission according to claim 2, wherein
the first engagement mechanism and the second engagement mechanism are arranged in the axial direction and driven by a common drive mechanism,
the drive mechanism includes an engagement member and a drive device, the engagement member operating in such a way as to selectively cause one of the first engagement mechanism and the second engagement mechanism to be brought into the engaged state, the drive device outputting drive force for moving the engagement member in the axial direction,
the drive force of the drive device drives the engagement member to one side in the axial direction, thereby bringing the first engagement mechanism into the engaged state, and bringing the second engagement mechanism into the released state, and
the drive force of the drive device drives the engagement member to another side in the axial direction, thereby bringing the first engagement mechanism into the released state, and bringing the second engagement mechanism into the engaged state.

5. The vehicle transmission according to claim 1, wherein
the first rotating element and the fourth rotating element are sun gears,
the second rotating element and the fifth rotating element are carriers,
the third rotating element and the sixth rotating element are ring gears including internal teeth, and
the output member is an output gear including external teeth, the output gear being arranged at a position that is on an outer side of the third rotating element in a radial direction and that overlaps with the third rotating element when viewed in the radial direction.

6. The vehicle transmission according to claim 2, wherein
the first rotating element and the fourth rotating element are sun gears,
the second rotating element and the fifth rotating element are carriers,
the third rotating element and the sixth rotating element are ring gears including internal teeth, and
the output member is an output gear including external teeth, the output gear being arranged at a position that is on an outer side of the third rotating element in a radial direction and that overlaps with the third rotating element when viewed in the radial direction.
